(19) United States
(12) Patent Application Publication
(10) Pub. No.: US 2015/0128993 A1
(43) Pub. Date: May 14, 2015

(54) CHAMBER CLEANING WHEN USING ACID CHEMISTRIES TO FABRICATE MICROELECTRONIC DEVICES AND PRECURSORS THEREOF

(71) Applicant: TEF FSI, Inc., Chaska, MN (US)

(72) Inventors: Erik R. Berg, Chaska, MN (US); Kevin L. Siefering, Excelsior, MN (US)

(21) Appl. No.: 14/539,160

(22) Filed: Nov. 12, 2014

Related U.S. Application Data
(60) Provisional application No. 61/903,693, filed on Nov. 13, 2013.

(51) Int. Cl. B08B 3/08

(52) U.S. Cl. CPC B08B 3/08
USPC 134/3

(57) ABSTRACT

The present invention provides treatment strategies that reduce contamination on wafer surfaces that are treated with acid chemistries. The strategies are suitable for use with a wide variety of wafers, including those including sensitive microelectronic features or precursors thereof. These strategies involve a combination of neutralizing and rinsing strategies that quickly and effectively remove residual acid and acid by-products from both the front side of workpiece(s) as well as from other processing chamber surfaces that can be causes of contamination.

### PRIORITY

The present non-provisional patent Application claims priority to U.S. Provisional Patent Application having Ser. No. 61/903,693, filed on Nov. 13, 2013, titled IMPROVED CHAMBER CLEANING WHEN USING ACID CHEMISTRIES TO FABRICATE MICROELECTRONIC DEVICES AND PRECURSORS THEREOF, wherein the entirety of said provisional patent application is incorporated herein by reference for all purposes.

### FIELD OF THE INVENTION

The present invention relates to methods for processing one or more microelectronic workpieces in a process chamber according to recipes that incorporate one or more treatments with acid chemistries. More particularly, the present invention relates to such methods in which neutralizing and rinsing of wafer and chamber surfaces are sequenced after acid treatment (s) to reduce particle, acid droplet, and haze contamination on the workpieces.

### BACKGROUND OF THE INVENTION

The manufacture of microelectronic devices may involve processing precursors of these devices (such precursors also referred to as wafers or workpieces herein) with at least one acid chemistry. Acid chemistries may be used for a variety of purposes. An exemplary use involves removing photoresist or photoresist residues from the workpieces. Another exemplary use involves using acid chemistry to etch silicon nitride.

A variety of acid chemistries are known. Exemplary acid chemistries include aqueous phosphoric acid, aqueous mixtures including phosphoric acid and sulfuric acid, aqueous sulfuric acid, aqueous mixtures including sulfuric acid and an oxidizing agent such as a peroxide or ozone; nitric acid; combinations of these, and the like. Mixtures of sulfuric acid and hydrogen peroxide are known as SPM chemistry or, alternatively, piranha chemistry.

After acid treatment, it is desirable to rinse workpiece and chamber surfaces thoroughly to remove the acid chemistry and/or acid by-products such as salts. Acid residue or salts thereof on chamber surfaces can migrate or otherwise transfer onto in-process workpieces. If this occurs when a wafer is dried or is drying, the falling debris tends to contaminate the workpiece to cause the workpiece or resultant devices to suffer from particle contamination, acid droplet contamination, haze, yield losses, etc. It is important, therefore, to effectively rinse both workpiece and chamber surfaces effectively.

One way to assess whether workpieces have been rinsed sufficiently following an acid treatment involves assessing whether particles, acid droplets, haze, or the like contaminate workpiece surfaces following the treatment regime. Particle contamination, acid droplet contamination, and/or a haze (such development(s) referred to collectively as contamination) on the workpiece surface generally indicates that the acid chemistry and by-products thereof, such as salts, have not been effectively rinsed from the workpiece or chamber surfaces or that contamination developed after rinsing.

Particle contamination or acid droplets may be detected in a variety of ways such as by using a laser-based, light scattering detection instrument. Such an instrument scans the surface being evaluated. Light is scattered by particles or acid droplets on the surface. The location(s) of scattered light correspond to particles, acid droplets, or other contamination. Such locations are counted, and the count corresponds to the number of particles or droplets on the surface. In many cases, it is unacceptable to practice a treatment that allows undue levels of such contamination to develop.

Due to the risk that salt by-products can cause contamination, yield losses, or the like, there is a strong bias in the industry to avoid salt formation during device manufacture. Accordingly, there has been a bias in the industry to attempt to rinse acid residue from wafer and chamber surfaces before exposing the wafer to subsequent chemistries that might have a tendency to react with acids to form salts. One strategy to remove acid from these surfaces involves rinsing workpieces and chamber surfaces with water. When using water alone for rinsing, substantial volumes of water may be needed to effectively rinse the chamber and workpiece surfaces. This not only uses a substantial amount of water, but rinsing merely with water alone can take too long to achieve desired throughput in some applications.

Further, acid residue on chamber surfaces is difficult to rinse away completely even with substantial rinsing. In particular, even though sulfuric acid is highly water soluble, this acid nonetheless is highly viscous and adheres to chamber surfaces tenaciously. Consequently, it is difficult to remove sulfuric acid residue from chamber surfaces using water alone even if rinsing of chamber surfaces occurs for an extended period.

Treatments that use less rinsing fluid and/or that accomplish rinsing faster generally involve neutralizing and removing the acid and salts thereof using a suitable neutralizing chemistry often in combination with one or more water rinses. For example, aqueous mixtures including ammonia and/or another alkaline reagent have been used to neutralize and remove acids and acid salts from workpiece surfaces. One example of an aqueous ammonia chemistry is generally referred to in the industry as the SC1 chemistry. The SC1 chemistry is widely used throughout the industry for particle removal and has multiple advantages. First, the ingredients are compatible with microelectronic materials and features in many instances. The chemistry etches lightly to help loosen particles, which makes the particles easier to remove. The chemistry also has zeta potential characteristics that help to prevent dislodged particles from re-depositing on the surface being treated.

The SC1 chemistry is prepared by combining ingredients including aqueous ammonia (generally in the form NH4OH in aqueous solution), aqueous hydrogen peroxide, and water. A typical SC1 formulation includes one part by volume aqueous ammonium hydroxide (29% by weight ammonium hydroxide), 4 parts by volume hydrogen peroxide (30% by weight peroxide), and 70 parts by volume water. Other formulations that are more concentrated or more dilute with respect to ammonium hydroxide and/or peroxide also have been used.

The SC1 chemistry often is used in combination with water rinse(s). An integrated treatment to remove resist on the front side of a workpiece therefore might involve a treatment sequence in which the front side of the workpiece is treated with an SPM reagent or other acid chemistry. This is followed by rinsing the front side of the workpiece and chamber surfaces with water. Then, after this rinsing, the front side of the workpiece is treated with an SC1 reagent. This is followed by rinsing the front side with water again. The workpiece is then dried. Some conventional processes treat the workpiece surface with aqueous peroxide or other oxidizing reagent in order to make the rinsing/neutralizing more effective

Unfortunately, even when following such a conventional protocol, undue amounts of particle contamination, haze, and other issues can still result. Therefore, there is a strong need for treatment strategies that reduce contamination when using acid chemistries to fabricate microelectronic devices.

### SUMMARY OF THE INVENTION

The present invention provides treatment strategies that reduce contamination on wafer surfaces. The strategies are suitable for use with a wide variety of wafers, including those including sensitive microelectronic features or precursors thereof. These strategies involve advantageous sequencing of a combination of neutralizing and rinsing treatments that quickly and effectively remove residual acid and acid by-products from both the front side of workpiece(s) as well as from other processing chamber surfaces that can cause contamination. In the practice of the present invention, the front side of the workpiece also is referred to as the first major surface, and the back side of the workpiece is referred to as the second major surface.

In one aspect, the present invention is based at least in part upon the appreciation that contamination can result not only from residual acid left on the front side of the workpiece itself, but also from residual acid and acid by-product material on the surrounding chamber walls if the residual acid and acid by-product material is unduly present when a workpiece is dried or drying. The present invention further appreciates that, even though wafer surfaces and chamber surfaces may be subjected to customized neutralizing and rinsing treatments as a follow up to acid treatments, neutralizing and rinsing sequences that are optimized for processing the workpiece surface(s) may not be optimum for processing chamber walls and vice versa.

In a conventional mode of practice, for example, rinsing strategies using predominantly water have been used to thoroughly rinse a wafer front side in a manner effective to avoid unduly damaging sensitive features. Chamber surfaces above the workpiece also are thoroughly rinsed with water at this early stage of a conventional recipe. Rinsing a spinning wafer is generally an effective and efficient way to remove acid residue from a wafer surface, but an overhead chamber surface is generally stationary. The acid residues on the stationary chamber walls are not easily rinsed with water alone due at least in part to the viscous and adhesion characteristics of the acid material. Indeed, without wishing to be bound, it is believed that rinsing the overhead chamber surfaces too soon might even form a water barrier over the acid residue, inhibiting rather than promoting residue removal. The chamber rinsing at this stage of a conventional practice tends to leave undue levels of acid residue on the chamber surfaces. Next, when the wafer and chamber rinses are followed by treating the wafer with a neutralizing chemistry, vapors from the neutralizing chemistry contact overhead chamber surfaces to form acid salts. No further direct rinsing of the chamber surfaces above the wafer occurs, though. This conventional practice, as a consequence, allows undue amounts of acid residue and acid salts to be present at later stages of processing when a wafer is dried or drying. These materials at that time have a tendency to migrate or otherwise transfer onto and contaminate the workpiece.

It is well known that salts are a source of contamination, and there is a strong bias in the industry to avoid salt formation. This is one reason that a conventional practice rinses chamber surfaces early but not later, as the expectation was that the rinsing would remove acid residue to avoid undue salt formation. The present invention appreciates that rinsing overhead chamber surfaces in a conventional manner promotes salt formation at an inopportune stage of processing rather than inhibiting contamination from the overhead surfaces.

The present invention appreciates that salt formation per se is not necessarily a problem, but rather the stage at which salts form is a key to more optimum performance. In particular, the present invention further appreciates that rinsing of the overhead chamber surface(s) is much more effective when it follows a neutralizing treatment on those surfaces instead of rinsing only before a neutralizing treatment. Without wishing to be bound, it is believed that the neutralizing chemistry quickly reacts with acid residues, converting them to highly water soluble salts. Converting acid residue to salts at an earlier stage is actually better, because the salts are very water soluble and show low adhesion to the chamber surfaces. Salts, therefore, very easy to remove from chamber surfaces with rinsing. Forming salts on chamber surfaces overlying the wafer and following that with rinsing of those surfaces allows the acid residue to be removed more easily to substantially reduce contamination risks. In contrast, forming salts later without rinsing those surfaces creates a greater risk that the acid residue would be a source of contamination.

The effectiveness of rinsing chamber surfaces after salt formation(and optionally before, if desired) is surprising as neutralizing chamber surfaces to purposely form salts prior to rinsing is counterintuitive. Salts conventionally had been viewed as contaminant particles, and the presence of salts had been desirably avoided. This is one reason that a conventional practice rinses chamber surfaces before potential salt formation, as the expectation was that the rinsing would remove acid residue to avoid undue salt formation. The present invention appreciates that converting the residue to salts at an earlier stage is actually better, because the salts are very water soluble and, therefore, very easy to remove from chamber and workpiece surfaces. Hence, the present invention further appreciates that purposefully forming salts earlier in the post-acid treatment regime allows early salt formation to be a benefit (easier to rinse) rather than a burden.

For example, according to an illustrative mode of practice, a treatment regime of the present invention might involve an acid treatment on wafer with a chemistry comprising sulfuric acid, and this is directly or indirectly followed by a treatment on wafer with a neutralizing chemistry including aqueous ammonia. Rinsing of wafer and/or chamber surfaces may be practiced prior to the neutralizing treatment, if desired. Ammonia vapors are generated that contact and react with acid residue on the overhead chamber surfaces. Ammonium sulfate is one salt that forms when ammonia and sulfuric acid react. Ammonium sulfate salt is highly water soluble. After allowing salt formation to occur on the overlying chamber surfaces, the chamber surfaces are rinsed with water. Ammonium sulfate easily dissolves and is easily removed from a surface by rinsing the overhead surface. By allowing salts on the overhead surface to form and then rinsing, the chamber clean is more effective, and particle contamination on the wafer are reduced. The acid residue is more completely removed from the overhead surfaces to reduce the risk that undue amounts of residue remain to contaminate the wafer later in the process. The improvement is seen as a dramatic reduction in light point defects (also referred to as particles) in metrology used to detect wafer surface contamination.

The treatment strategies are readily incorporated into tools that are commercially available or that might already be an existing resource in the facility of the user. Preferably, the strategies are used in single wafer processing systems. An exemplary tool in which these strategies may be used is the versatile single wafer processing tool available under the trade designation ORION™ from TEL FSI, Inc., Chaska, Minn.

In one aspect, the present invention relates to a method of cleaning a chamber; comprising the steps of:
(a) positioning a microelectronic device precursor in a treatment chamber comprising an interior chamber surface that overlies the precursor;
(b) treating the workpiece with an acidic composition under conditions such that an acid residue collects on at least a portion of the interior chamber surface;
(c) causing a neutralizing composition, which can be a liquid and/or vapor, and which comprises at least one base, to contact acid residue on the interior chamber surface; and
(d) after the neutralizing composition contacts the acid residue on the interior chamber surface, rinsing the interior chamber surface. In some embodiments in which the composition of step (c) of this aspect of the present invention is a liquid composition comprising aqueous ammonia, this rinsing step is optional inasmuch as rinsing the interior surface causes salts to form together with effective rinsing action.

In another aspect, the present invention relates to a method of processing a microelectronic device precursor, comprising the steps of:
(a) positioning a microelectronic device precursor in a treatment chamber comprising an interior chamber surface that overlies the precursor;
(b) treating the workpiece with an acidic composition under conditions such that a portion of the acidic composition collects on at least a portion of the interior chamber surface;
(c) after treating the workpiece with the acidic composition, optionally rinsing the microelectronic precursor with a rinsing liquid without rinsing the interior chamber surface with a rinsing liquid;
(d) prior to rinsing the interior chamber surface with a rinsing liquid, treating the workpiece with a second treatment composition comprising a base in a manner such that a portion of the second treatment composition contacts at least a portion of the acid residue on the interior chamber surface and wherein the contact forms a reaction product on the interior surface comprising a salt;
(e) after a portion of the second treatment composition contacts at least a portion of the acid residue on the interior chamber surface, rinsing the interior surface with a rinsing liquid.

In another aspect, the present invention relates to a method of cleaning a chamber; comprising the steps of:
(a) positioning a microelectronic device precursor in a treatment chamber comprising an interior chamber surface that overlies the precursor;
(b) treating the workpiece with an acidic composition under conditions such that an acid residue collects on at least a portion of the interior chamber surface;
(c) rinsing the interior chamber surface with an aqueous liquid composition comprising aqueous ammonia; and
(d) after rinsing the interior chamber surface, rinsing the workpiece.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention. All patents, pending patent applications, published patent applications, and technical articles cited herein are incorporated herein by reference in their respective entireties for all purposes.

According to one preferred mode of practice, one or more microelectronic device precursors are provided. Each precursor generally incorporates microelectronic device features or precursors thereof supported on a suitable substrate, such as a semiconductor substrate. Exemplary semiconductor substrates may include one or more semiconductor materials such as silicon, germanium, silicon carbide, silicon germanium, germanium arsenide, germanium nitride, germanium antimonide, germanium phosphide, aluminum arsenide, aluminum nitride, aluminum antiminide, aluminum phosphide, boron arsenide, boron nitride, boron phosphide, indium arsenide, indium nitride, indium antimonide, indium phosphide, aluminum gallium arsenide, indium gallium arsenide, indium gallium phosphide, aluminum indium arsenide, aluminum indium antimonide, copper oxide, copper indium gallium, copper indium gallium selenide, copper indium gallium sulfide, copper indium gallium sulfide selenide, Aluminium gallium indium phosphide, Aluminium gallium arsenide phosphide, Indium gallium arsenide phosphide, Indium gallium arsenide antimonide, Indium arsenide antimonide phosphide, Indium arsenide antimonide phosphide, Aluminium indium arsenide phosphide, Aluminium gallium arsenide nitride, Indium gallium arsenide nitride, Indium aluminium arsenide nitride, gallium arsenide, Gallium arsenide antimonide nitride, Gallium indium nitride arsenide antimonide, Gallium indium arsenide antimonide phosphide, Cadmium selenide, Cadmium sulfide, Cadmium telluride, Zinc oxide, Zinc selenide, Zinc sulfide, Zinc telluride, Cadmium zinc telluride, Mercury cadmium telluride, Mercury zinc telluride, Mercury zinc selenide, Cuprous chloride, Copper sulfide, Lead selenide, Lead(II) sulfide, Lead telluride, Tin sulfide, Tin sulfide, Tin telluride, Lead tin telluride, Thallium tin telluride, Thallium germanium telluride, Bismuth telluride, Cadmium phosphide, Cadmium arsenide, Cadmium antimonide, Zinc phosphide, Zinc arsenide, Zinc antimonide, Titanium dioxide, anatase, Titanium dioxide, rutile, Titanium dioxide, Copper(I) oxide, Copper(II) oxide, Uranium dioxide, Uranium trioxide, Bismuth trioxide, Tin dioxide, Barium titanate, Strontium titanate, Lithium niobate, Lanthanum copper oxide, combinations of these, and the like.

In a typical mode of practice, the precursor workpiece(s) as provided are positioned in a treatment chamber having one or more interior chamber surfaces that overlies the precursor(s). The ORION™ tool includes a versatile lid assembly overlying the workpiece. The lid assembly can be raised and lowered to help load workpieces to and from the process chamber. Plumbing and dispense features are integrated into the lid assembly to allow treatment materials to be introduced into the chamber in various ways. One dispense feature allows liquids to be dispensed generally onto the center of a spinning workpiece as a liquid stream from a generally central dispense nozzle. Another dispense feature allows atomized treatment materials to be sprayed onto an underlying spinning workpiece. The lid assembly also has a large underside that helps to form a barrier over the workpiece that, in practical effect, serves as a chamber lid. The lid assembly has a geometry so that the headspace over the workpiece tapers from a relatively wide zone over the workpiece center to a narrower zone over the periphery of the workpiece. The resultant tapering flow channel helps to create optimum flows of gases on and over the spinning wafer. It can be appreciated, therefore, when using the ORION™ tool, the underside of the lid assembly includes surfaces that directly overly the precursor being processed.

According to an illustrative treatment recipe when using a treatment apparatus such as the ORION™ tool, the precursor(s) are treated by spraying with an acid chemistry. Spraying onto the precursor(s) causes an acid residue to indirectly collect on at least a portion of the chamber surfaces, including those on the lid assembly that directly overly the precursor if the ORION™ tool is being used. Acid processing can be used for a variety of reasons. As one reason, the acid chemistry can be used to remove photoresist or residues thereof or etching residues from workpiece surfaces. Acid chemistries also may be used to etch SiN, TiN, Ti, W, Ni, NiPt alloy, cobalt, CoNi alloys, other metals or combinations of metals, and/or the like.

A wide variety of different acid chemistries may be used to treat precursor workpieces in the practice of the present invention. Exemplary acid chemistries for removing photoresist or metal are aqueous solutions including one or more of sulfuric acid, phosphoric acid, and/or ingredients that are converted into such acids in situ. One useful acid chemistry is formulated from ingredients including about 1 to about 100 parts by volume of concentrated sulfuric acid (98 weight percent sulfuric acid in water) per about 1 part by volume of aqueous hydrogen peroxide (30 weight percent hydrogen peroxide in water). A chemistry formulated from sulfuric acid and hydrogen peroxide is referred to in the industry as the SPM chemistry and/or the Piranha chemistry. Another exemplary acid chemistry is formulated from about 0.5 to about 2 parts by volume of concentrated sulfuric acid (98 weight sulfuric acid in water) per about 1 part of by volume of aqueous phosphoric acid (85 weight percent phosphoric acid in water). These formulations optionally may include additional amounts of water if desired in addition to the water already present in the reagents. For example, formulations may include an additional Ito 10,000 parts by weight of water per part by weight of acid included in the formulation.

The acidic chemistry is caused to contact at least the first major surface of the workpiece(s) being processed under conditions effective to carry out the desired treatment such as to remove at least a portion of the photoresist that may be present on the surface. In a typical treatment, the acidic chemistry may be applied to the first major surface in a variety of ways including spraying onto all or a portion of a chord of the wafer. In some suitable modes of practice, the acid chemistry is co-introduced with steam as described in PCT Pat. Pub. Nos. WO 2007/062111 and WO 2008/143909, each of which is incorporated herein by reference in its respective entirety for all purposes. Technology for co-introducing acid chemistry with steam under the trade designation ViPR+® is commercially available from TEL FSI, Inc. (Chaska, Minn.) and is practiced effectively on the ORION™ tool.

Often, the workpiece spins during an acid treatment at a suitable rpm or a combination of spin rates. Exemplary spin rates may be in the range from about 10 rpm to about 1000 rpm, often about 25 rpm to about 500 rpm, or even about 50 rpm to about 300 rpm.

The acidic chemistry may be provided at one or more suitable temperatures. Suitable temperatures may be below ambient temperature, at ambient temperature, or above ambient temperature. In one mode of practice, an SPM chemistry is provided at a temperature of about 80° C. to 240° C. Co-introduction with steam may cause the temperature of the chemistry to increase in situ to temperatures in the range from 100° C. to 255° C.

The acid chemistry is supplied at a suitable flow rate effective to provide the desired action within a reasonable time period. If the flow rate is too low, the process may take longer than desired to complete. If the flow rate is too high, too much reagent may be used to accomplish the same performance as might be achieved using a lower flow rate. Balancing such concerns, an acid reagent may be supplied at a flow rate in the range from about 200 ml/min to about 2000 ml/min, preferably about 800 ml/min to about 1500 ml/min per workpiece for a time period ranging from about 10 seconds to about 180 seconds, preferably about 15 seconds to about 60 seconds.

After the acid treatment, an optional transition step may be practiced as a transition between the acid treatment step and one or more subsequent rinsing/neutralization treatments. For example, after an acid treatment using the SPM chemistry, it may be desirable to treat the first major surface and optionally the second major surface (often referred to as the back side) of the wafer one or more times with one or more oxidizing reagents in order to help improve the efficacy of the subsequent rinsing/neutralizing step. Exemplary oxidizing reagents include aqueous peroxide solution, ozone gas, a mixture of steam and ozone, and/or ozonated water.

In an illustrative mode of practice, a suitable oxidizing reagent is an aqueous solution obtained by formulating from about 1 part by volume of aqueous hydrogen peroxide (30 weight percent peroxide) and 0 to about 10 parts by volume of water. The oxidizing reagent may be provided at one or more suitable temperatures. Suitable temperatures may be below ambient temperature, at ambient temperature, or above ambient temperature. In one mode of practice, the oxidizing reagent is provided at ambient temperature.

The workpiece may spin at any suitable spin rate(s) during the course of the optional treatment with the oxidizing reagent(s). The spin rates discussed above with respect to the acid treatment would be suitable.

An oxidizing reagent is supplied at a suitable flow rate effective to provide the desired action within a reasonable time period. If the flow rate is too low, the process may take longer than desired to complete. If the flow rate is too high, too much reagent may be used to accomplish the same performance as might be achieved using a lower flow rate. Balancing such concerns, an oxidizing reagent may be supplied at a flow rate in the range from about 30 ml/min to about 1500 ml/min, preferably about 85 ml/min to about 500 ml/min for a time period ranging from about 5 seconds to about 30 seconds, preferably about 10 seconds to about 20 seconds.

If the transition treatment with an oxidizing reagent is performed in two or more cycles, the workpiece desirably may be rinsed with deionized water between the oxidizing treatments. The oxidizing reagent may be the same or different in each such cycle.

Optionally, the spinning wafer surface and/or the overlying chamber surfaces, may be directly rinsed at this stage before further treatment. Rinsing the wafer surface at this stage allows a substantial portion of the acid and oxidizing reagent (if any) residues to be easily removed from the wafer surface. It is preferred in some modes of practice if the wafer but not the overlying chamber surfaces are rinsed at this stage if water alone is used for rinsing. Rinsing the overlying chamber surfaces at this stage with water alone may involve using too much water to accomplish a desired degree of rinsing, more cycle time to reduce overall throughput, more electrical power to handle extended rinsing, or the like. Direct rinsing of the overlying surfaces at this stage with water alone could cause the overlying surfaces to be coated with a water film that unduly shields the acid residue on those surfaces from desired reaction with the neutralizing chemistry vapors. This could, in some instances, inhibit the formation of acid salts according to principles of the present invention on the overlying surfaces at least to some degree. By avoiding direct rinsing of the overlying chamber surfaces with water alone at this stage, acid residue on those surfaces remains sufficiently exposed to be able to react with neutralizing chemistry vapors as described herein. Some overspray from direct rinsing of the wafer surface may contact the overlying surfaces, but generally this is too little to form a shield against salt formation when the acid residue contacts neutralizing vapors as described below. After allowing vapors to react with acid residue as described below, a subsequent rinse may be then applied to accomplish effective rinsing in a short time.

In other modes of practice, the overlying chamber surface optionally can be rinsed with an aqueous composition comprising ammonia, e.g., an aqueous ammonia chemistry having a formulation as described below. Using an aqueous ammonia chemistry at this stage to rinse the overlying chamber surfaces is fast and effective. The ammonia reacts with the acid residue, converting the residue into salts that are highly water soluble and much more easily rinsed away than the acid. When using a liquid SC1 chemistry to rinse the overlying chamber surfaces, acid residue is so easily removed, subsequent rinsing of the overlying chamber surfaces at a later stage of treatment is optional.

Next, after the acid treatment and optional rinsing of the wafer and chamber surfaces, a neutralizing chemistry in the form of a second treatment composition comprising a base is dispensed directly onto the spinning wafer surface. As an option, a neutralizing chemistry can also be directly dispensed onto the overlying chamber surfaces, but this is not required to form salts on the overlying surfaces As described further below, the neutralizing chemistry dispensed on the wafer generates fumes or a vapor that also contacts and reacts with acid residue on the overlying chamber surfaces to form salts that are easily rinsed. The neutralizing chemistry is dispensed onto the workpiece for a suitable period effective to accomplish the desired level of rinsing and neutralization. In many embodiments, this co-dispensing occurs for a period in the range from about 3 seconds to about 300 seconds. In one embodiment, a period of 10 to 30 seconds would be suitable.

A preferred neutralizing chemistry includes aqueous ammonia and aqueous hydrogen peroxide. Exemplary embodiments of this neutralizing chemistry may be obtained from flow rates that combine from about 1 to about 40 parts by volume of aqueous ammonia (29 weight percent ammonium hydroxide), about 1 to about 40 parts by volume of aqueous hydrogen peroxide (30 weight percent peroxide), and about 200 parts by volume of water. In a preferred embodiment, a neutralizing chemistry is obtained from flow rates that combine 1 part by volume of aqueous ammonia (29 weight percent ammonium hydroxide), 1 to 5 parts by volume of aqueous hydrogen peroxide (30 weight percent peroxide), and 70 to 80 parts by volume water. In some embodiments, even more dilute solutions can be used effectively. Exemplary dilute ammonia solutions, for example, comprise water and ammonia, where the weight ratio of water to ammonia is in the range from 5:1 to 100,000:1, preferably 100:1 to 10,000:1. This same neutralizing chemistry optionally may be used, if desired, to effectively rinse overlying chamber surfaces at an earlier stage as described above.

The neutralizing chemistry independently may be dispensed onto the wafer and optionally the overlying surfaces at a flow rate within a wide range. Exemplary flow rates per wafer are in the range from about 0.3 liters/min to about 20 liters/min, preferably from about 0.4 liters/min to about 5 liters/min, more preferably about 0.5 liters/min to about 3 liters/min.

The second treatment composition typically is dispensed onto the spinning workpiece as a fluid admixture, preferably a liquid admixture. Fumes or vapors emanate from the second composition. These fumes generally comprise a vapor phase amount of base corresponding to the base included in the second treatment composition itself.

The generated fumes or vapors contact acid residue on the interior chamber surfaces overlying the spinning workpiece. As a consequence, the base and acid residue react. Without wishing to be bound, it is believed that the reaction forms water soluble salt(s). For instance, the reaction between ammonia vapor and acid residue of sulfuric acid forms highly water soluble ammonium sulfate. After the contact, the acid residue and/or reaction product of the residue and the vapor is easily rinsed away by directly rinsing the overlying chamber surfaces using a suitable rinsing fluid such as water or a neutralizing chemistry. Optionally, peroxide also may be included in the rinsing composition at this stage. In the case of the ORION™ tool, the tool incorporates features that allow a swirling, flowing rinse to be introduced onto the underside of that tool's lid assembly structure. This swirling, flowing rinse flows outward toward the rim of the lid assembly where a vacuum is used to remove the rinse liquid from the lid through an array of passages around the periphery of the lid. By rinsing after salt formation (or with salt formation as discussed above), the rinsing action is substantially more effective at cleaning the underside of the lid assembly. Because the salt is so easily removed, salt formation assists this cleaning action rather than the salts serving unduly as a source of contamination.

This rinsing of chamber surfaces overlying the workpiece may be coordinated with rinsing of the workpiece. For example, in a preferred mode of practice, the neutralizing dispense on the workpiece ends with a transition to a subsequent rinsing step in which at least a portion of the overlying chamber surfaces and the workpiece surface(s) are rinsed with a suitable rinsing liquid such as deionized water. This transition can be accomplished by simply stopping the flow of neutralizing chemistry onto the second major surface while flows of a rinsing fluid are co-dispensed onto the wafer and chamber surfaces. The rinsing action then continues for a suitable time period. The chamber surfaces and wafer surfaces can be rinsed for the same duration or different durations. In some modes of practice, rinsing of the overlying surfaces stops first while rinsing on the wafer continues afterward for a desired duration.

At this stage, acid and acid byproducts are effectively and thoroughly rinsed and removed from the workpiece and process chamber surfaces. The workpiece can be further rinsed (if desired) and then dried or otherwise handled for subsequent processing.

Desirably, any one or more of the process steps described herein are carried out in a protective atmosphere. Exemplary protective atmospheres include nitrogen, argon, carbon dioxide, clean dry air, combinations of these, and the like.

### EXAMPLE 1

The principles of the present invention dramatically and consistently reduce particle contamination. In one experiment, particle contamination associated with a conventional process was compared to a process incorporating principles of the present invention. An ORION™ tool was used to carry out the experiments. The conventional process was used on 51 test wafer workpieces. Each wafer was rinsed with deionized (DI) water. The wafer surface was then treated with an acid chemistry including sulfuric acid and hydrogen peroxide. The wafer surface was rinsed with DI water. After the DI rinse on wafer started, the underside of the lid assembly overlying the wafer was rinsed. The on wafer rinse was stopped, and on wafer treatment with SC1 chemistry started. The lid assembly rinse continued but then was stopped while the on wafer SC1 treatment continued. Thus, the lid assembly rinse was carried out in a manner so that it overlapped with a last portion of the on wafer rinse and a first portion of the on wafer SC1. More than half of the lid assembly rinse occurred prior to start of the SC1 treatment. The SC1 treatment was stopped. The wafer was rinsed and dried. Metrology (KLA-Tencor SP2 light scattering surface defect measurement was used to assess the added particles (adders>45 nm) and 18+/−12 adders>45 nm were observed for the 51 test wafers.

The process was repeated using 58 test wafer workpieces, except that the lid assembly rinse was delayed so that the rinse occurred after salts were allowed to form on underlying surfaces of the lid assembly. In this case, no portion of the lid assembly rinse occurred during the time that each wafer was treated with SC1 chemistry or rinsed prior to the SC1 treatment. Instead, the lid assembly rinse was delayed until the wafer was rinsed after the SC1 treatment. Fumes emanating from the the SC1 treatment were able to contact the underside of the lid assembly before it was directly rinsed. Metrology (SP2) was used to assess the added particles (adders>45 nm) and 6+/−3 adders>45 nm were observed for the 58 test wafers. The added particles were reduced by 67% from 18 to 6, and the variation was reduced by a factor of 4 from +/−12 to +/−3.

The results are counterintuitive. The process of the present invention purposefully allowed the underside of the lid assembly to get contaminated with salts at an early stage, because at this stage the salts can be very easily removed by subsequent rinsing. This is contrasted with the conventional approach in which salts formed later and without subsequent rinsing, which led to greater particle contamination. Remarkably, leaving chamber surfaces dirty in terms of salts for a longer time provides a cleaner wafer when salt formation is followed by rinsing of the chamber surfaces.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A method of cleaning a chamber; comprising the steps of:
(a) positioning a microelectronic device precursor in a treatment chamber comprising an interior chamber surface that overlies the precursor;
(b) treating the workpiece with an a, acidic composition under conditions such that an acid residue collects on at least a portion of the interior chamber surface overlying the workpiece;
(c) causing a neutralizing composition comprising at least one base to contact acid residue on the interior chamber surface; and
(d) after the neutralizing composition contacts the acid residue, rinsing the interior chamber surface.

2. A method of processing a microelectronic device precursor, comprising the steps of:
(a) positioning a microelectronic device precursor in a treatment chamber comprising an interior chamber surface that overlies the precursor;
(b) treating the workpiece with an acidic composition under conditions such that a portion of the acidic composition collects on at least a portion of the interior chamber surface;
(c) after treating the workpiece with the acidic composition, optionally rinsing the microelectronic precursor with a rinsing liquid without rinsing the interior chamber surface with a rinsing liquid;
(d) prior to rinsing the interior chamber surface with a rinsing liquid, treating the workpiece with a second treatment composition comprising a base in a manner such that a portion of the second treatment composition contacts at least a portion of the acid residue on the interior chamber surface and wherein the contact forms a reaction product on the interior surface comprising a salt;
(e) after a portion of the second treatment composition contacts at least a portion of the acid residue on the interior chamber surface, rinsing the interior surface with a rinsing liquid.

3. The method of claim 1, wherein the sprayed acidic composition incorporates one or more ingredients including at least sulfuric acid and/or phosphoric acid.

4. The method of claim 1, wherein the second treatment composition incorporates one or more ingredients including at least ammonia.

5. The method of claim 4, wherein the water soluble salt includes ammonium sulfate.

6. The method of claim 1, wherein the salt comprises a water soluble salt.

7. The method of claim 1, wherein the sprayed acidic composition incorporates one or more ingredients including at least phosphoric acid.

8. The method of claim 1, wherein the sprayed acidic composition incorporates ingredients including at least phosphoric acid and sulfuric acid.

9. The method of claim 1, wherein the interior chamber surface is a lower surface of a barrier structure, wherein step (e) comprises flowing the rinsing liquid onto the interior chamber surface, and wherein the method further comprises using a vacuum to remove the flowing rinsing liquid from the interior chamber surface through one or more passageways in fluid communication with the lower surface.

10. The method of claim 9, wherein at least a portion of the aspiration passageways comprises an array of passageways having a plurality of inlets located proximal to an outer peripheral edge of the lower surface.

11. The method of claim 1, wherein the sprayed acidic composition further comprises an oxidizing agent.

12. The method of claim 11, wherein the sprayed acidic composition is aqueous and the oxidizing agent comprises a peroxide.

13. The method of claim 11, wherein the sprayed acidic composition is aqueous and the the oxidizing agent comprises ozone.

14. The method of claim 1, wherein the sprayed acidic composition has a temperature of at least 80° C.

15. The method of claim 1, wherein step (b) comprises dispensing water vapor into the chamber.

16. The method of claim 15, wherein step (b) comprises using the water vapor to atomize the acidic composition.

17. The method of claim 15, wherein the acidic composition is dispensed into the chamber through a first array of injection openings located above the precursor, wherein the water vapor is dispensed into the chamber through a second array of injection openings in a manner such that the dispensed acidic composition and water vapor collide and mix in a space above the precursor to form a spray that contacts the precursor; and wherein the first and second arrays of injection openings are positioned above the precursor

18. The method of claim 17, wherein step (b) further comprises rotating the precursor during at least a portion of the time that the acidic composition and the water vapor are dispensed.

19. The method of claim 1, wherein the interior chamber surface is a lower surface of a barrier structure, wherein step (e) comprises flowing the rinsing liquid onto the interior chamber surface.

20. The method of claim 1, wherein step (3) comprises dispensing the rinsing liquid at a temperature of at least 40° C.

21. The method of claim 1, wherein step (3) comprises dispensing the rinsing liquid at a temperature of at least 50° C.

22. The method of claim 1, wherein the interior surface comprises quartz.

23. The method of claim 1, further comprising drying the microelectronic precursor.

24. A method of cleaning a chamber; comprising the steps of:
(a) positioning a microelectronic device precursor in a treatment chamber comprising an interior chamber surface that overlies the precursor;
(b) treating the workpiece with an a, acidic composition under conditions such that an acid residue is on at least a portion of the interior chamber surface overlying the workpiece;
(c) causing a composition comprising aqueous ammonia to contact acid residue on the interior chamber surface; and
(d) after the composition contacts the acid residue, rinsing the interior chamber surface.

25. The method of claim 24, wherein the composition comprising aqueous ammonia comprises a weight ratio of water to ammonia in the range from 5:1 to 100,000:1.

26. A method of cleaning a chamber; comprising the steps of:
(a) positioning a microelectronic device precursor in a treatment chamber comprising an interior chamber surface that overlies the precursor;
(b) treating the workpiece with an acidic composition under conditions such that an acid residue collects on at least a portion of the interior chamber surface;
(c) rinsing the interior chamber surface with an aqueous liquid composition comprising aqueous ammonia; and
(d) after rinsing the interior chamber surface, rinsing the workpiece.
